(19) United States
(12) Patent Application Publication
(10) Pub. No.: US 2006/0259578 A1
(43) Pub. Date: Nov. 16, 2006

(54) System and method for discovering wireless mobile applications

(76) Inventors: Brindusa Fritsch, Toronto (CA); Sean Paul Taylor, Milton (CA); Michael Shenfield, Richmond Hill (CA)

Correspondence Address: Gowling Lafleur Henderson LLP, 2600-160 Elgin Street, Ottawa, ON, K1P 1C3, CA

(21) Appl. No.: 11/405,593

(22) Filed: Apr. 18, 2006

Related U.S. Application Data
(60) Provisional application No. 60/672,044, filed on Apr. 18, 2005.

(51) Int. Cl. G06F 15/16

(52) U.S. Cl. 709/217

(57) ABSTRACT

A client application matching system and methods of providing and obtaining client applications that match a thin client implementation are provided. The system comprises a publishing module for publishing a client application to a discovery service acting as a wrapper to a UDDI registry, a matching module for searching the UDDI registry for client applications that match a thin client implementation by calling an inquiry on the discovery service and a deployment module for retrieving from a back-end service, and transferring to a client, a client application in response to the inquiry. The method of providing comprises the steps of publishing client application information to a discovery service, receiving an inquiry for a client application matching a binding template criteria and sending the client application to the device in response to the inquiry. The method of obtaining comprises the steps of storing on a device a thin implementation of a client application, searching in a UDDI registry for a client application that matches binding template criteria associated with the thin implementation and receiving the client application in response to the step of searching.

This non-provisional application claims benefit of U.S. Provisional Application No. 60/672,044 filed Apr. 18, 2005, which is hereby incorporated by reference.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

The present patent disclosure relates generally to a communication system for providing communication to a plurality of devices and specifically to a system and method for discovering wireless mobile applications on such devices.

### BACKGROUND

Due to the proliferation of wireless networks, there are a continually increasing number of wireless devices in use today. These devices include mobile telephones, personal digital assistance (PDAs) with wireless communication capabilities, two-way pagers and the like. Concurrently with the increase of available wireless devices, software applications running on such devices have increased their utility. For example, the wireless device may include an application that retrieves a weather report for a list of desired cities or an application that allows a user to shop for groceries. These software applications take advantage of the ability to transmit data of the wireless network in order to provide timely and useful services to users, often in addition to voice communication. However, due to a plethora of different types of devices, restricted resources of some devices, and complexity of delivering large amounts of data to the devices, developing software applications remains a difficult and time-consuming task.

Currently, devices are configured to communicate with Web services through Internet-based browsers and/or native applications. Browsers have the advantage of being adaptable to operate on a cross-platform basis for a variety of different devices, but have a disadvantage of requesting pages (screen definitions in hyper-text markup language (HTML)) from the Web service, which hinders the persistence of data contained in the screens. A further disadvantage of browsers is that the screens are rendered at runtime, which can be resource intensive. Applications for browsers are efficient tools for designing platform independent applications. Accordingly, different runtime environments, regardless of the platform, execute the same application. However, since difference wireless devices have different capabilities and form factors, the application may not be executed or displayed as desired. Further, browser-based applications often require significant transfer bandwidth to operate efficiently, which may be costly or even unavailable for some wireless devices.

Universal Description, Discovery and Integration (UDDI) is a group of specifications that allow providers to publish information about their Web services and allow Web service requesters to inquire about that information to find a Web service and to be able to run the Web service. Technically, UDDI consists of an XML schema that defines four core data structures—Business, Service, Binding and Programmatic interface—and a set of APIs that operate on those structures. The architecture of UDDI allows for public and private registries. Private registries are aimed for companies offering services to trusted business associates and vendors using the services. Public registries for those offering services that are to be offered publicly in either a licensing or shareware manner. UDDI registries provide a key advantage over standard software release management practices. As new or updated versions of a Web service are released, a UDDI registry allows the service to be put to use immediately by the requesting application without any recoding or reintegration work.

Wireless Mobile Applications (WMAs) follow a similar paradigm. Typically, WMAs offer describable services available either publicly or privately. WMAs require a simple language agnostic protocol under which to operate using publish and inquiry methods.

There is a need for a way of discovering wireless mobile-based applications on devices to obviate or mitigate at least some of the aforementioned disadvantages.

### BRIEF DESCRIPTION OF THE DRAWINGS

An embodiment of the patent disclosure will now be described by way of example only with reference to the following drawings in which:

FIG. 1 shows in a schematic diagram an example of a network facilitating wireless mobile applications;

FIG. 2 shows in a detailed component diagram an example of the application gateway shown in FIG. 1;

FIG. 3 shows in a flow diagram an example of a wireless mobile application communication model;

FIG. 4 shows in a sequence diagram an example of a communication sequence for the wireless mobile application communication model of FIG. 3;

FIG. 5 shows in an interface diagram the discovery server of FIG. 2 in greater detail for discovering wireless mobile applications;

FIGS. 6a, 6b, and 6c show in component diagrams examples of UDDI structures for use in embodiments of the present patent disclosure;

FIG. 7 shows in a template record an example of a UDDI registry in accordance with an embodiment of the present patent disclosure;

FIG. 8 shows in a flow diagram of the network of FIG. 1 using the UDDI registry of FIG. 7;

FIG. 9 shows in a component diagram an example of a client application matching system, in accordance with an embodiment of the present patent disclosure;

FIG. 10 shows in a flowchart an example of a method of providing client applications that match thin implementations, in accordance with an embodiment of the client application matching system; and

FIG. 11 shows in a flowchart an example of a method of obtaining client applications that match thin implementations, in accordance with an embodiment of the client application discovery system.

### DETAILED DESCRIPTION OF THE PREFERRED EMBODIMENT

In accordance with an aspect of the present patent disclosure there is provided a client application matching system for providing and obtaining client applications that match a thin client implementation. The system comprises a publishing module for publishing a client application to a discovery service acting as a wrapper to a UDDI registry, a matching module for searching the UDDI registry for client applications that match a thin client implementation by calling an inquiry on the discovery service and a deployment module for retrieving from a back-end service, and transferring to a client, a client application in response to the inquiry.

In accordance with another aspect of the present patent disclosure there is provided a method of providing client applications that match a thin client implementation. The method comprises the steps of publishing client application information to a discovery service, receiving an inquiry for a client application matching a binding template criteria and sending the client application to the device in response to the inquiry.

In accordance with another aspect of the present patent disclosure there is provided a method of obtaining client applications that match a thin client implementation. The method comprises the steps of storing on a device a thin implementation of a client application, searching in a UDDI registry for a client application that matches binding template criteria associated with the thin implementation and receiving the client application in response to the step of searching.

In accordance with another aspect of the present patent disclosure there is provided a system for discovering Web services for a wireless device. The system comprises a discovery server including a registry for discovering Web services and an application gateway server for communicating with a plurality of mobile devices. The registry includes storage for thin clients for matching Web services with various mobile devices. The application gateway server is configured for communication with a back-end service and the discovery server.

In accordance with another aspect of the present patent disclosure there is provided a system for discovering Web services for a device. The system comprises a discovery server for providing Web services for a variety of devices and a registry for discovering Web services. The registry including storage for thin clients for matching Web services with various devices.

In accordance with another aspect of the present patent disclosure there is provided a method of providing client applications that match thin implementations. The method comprises the steps of publishing client application information to a discovery service, receiving an inquiry for a client application matching a binding template criteria and sending the client application to the device in response to the inquiry.

In accordance with another aspect of the present patent disclosure there is provided a computer-readable medium storing instructions or statements for use in the execution in a computer of a method providing client applications that match thin implementations. The method comprises the steps of publishing client application information to a discovery service, receiving an inquiry for a client application matching a binding template criteria and sending the client application to the device in response to the inquiry.

In accordance with another aspect of the present patent disclosure there is provided a propagated signal carrier carrying signals containing computer-executable instructions that can be read and executed by a computer. The computer-executable instructions are used to execute a method of providing client applications that match thin implementations. The method comprises the steps of publishing client application information to a discovery service, receiving an inquiry for a client application matching a binding template criteria and sending the client application to the device in response to the inquiry.

In accordance with another aspect of the present patent disclosure there is provided a computer-readable medium storing instructions or statements for use in the execution in a computer of a method of obtaining client applications that match thin implementations. The method comprises the steps of storing on a device a thin implementation of a client application, searching in a UDDI registry for a client application that matches binding template criteria associated with the thin implementation and receiving the client application in response to the step of searching.

In accordance with another aspect of the present patent disclosure there is provided a propagated signal carrier carrying signals containing computer-executable instructions that can be read and executed by a computer. The computer-executable instructions are used to execute a method of obtaining client applications that match thin implementations. The method comprises the steps of storing on a device a thin implementation of a client application, searching in a UDDI registry for a client application that matches binding template criteria associated with the thin implementation and receiving the client application in response to the step of searching.

Accordingly the present patent disclosure provides for discovering wireless mobile applications for wireless device mobile services.

The goal of the UDDI specification is to enable publication and discovery of Web services exclusively. Other types of applications that can be described, published, discovered and widely made available to users (e.g., mobile applications) can be stored in a UDDI registry.

Accordingly, UDDI is used in a unique way when native Web service entries are enhanced to point to known thin client implementations (e.g., a wireless application or a website). The description of one or more thin client implementations may reside on the same UDDI registry as the native Web service or another UDDI registry or the application location can be described solely using a URL (e.g., a website).

Conveniently, a specific terminal may request a matching application for the Web service back-end.

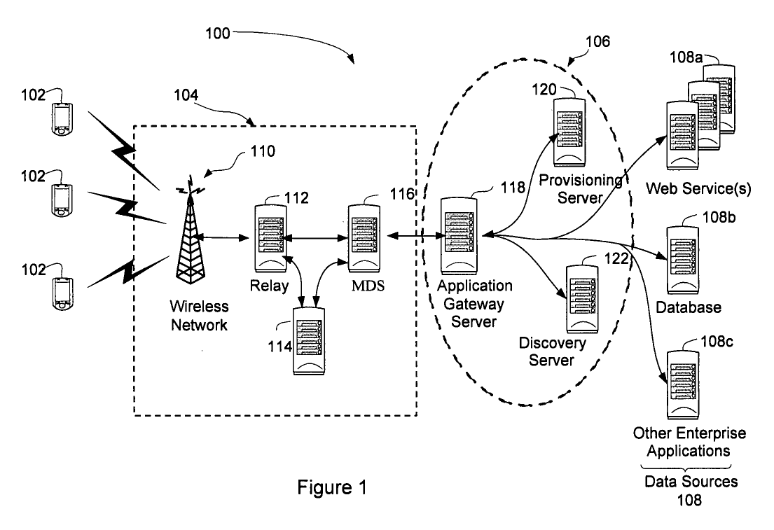

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of back-end services 108.

The wireless devices 102 are typically personal digital assistants (PDAs), such as a BlackBerry™ by Research in Motion for example, but may include other devices. Each of the wireless devices 102 includes a runtime environment (RE) capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML code in some implementations. Therefore, since the applications are compartmentalized, a common application can be written for multiple devices by providing corresponding presentation components without having to rewrite the other components. Further, large portions of the responsibility of typical applications are transferred to the runtime environment for the component application. The details of the component applications are described at the end of this description.

The wireless devices 102 are in communication with the application gateway 106 via the communication network 104. Accordingly, the communication network 104 may include several components such as a wireless network 110, a relay 112, a corporate server 114 and/or a mobile data server 116 for relaying data between the wireless devices 102 and the application gateway 106.

The application gateway 106 comprises a gateway server 118 a provisioning server 120 and a discovery server 122. The gateway server 118 acts as a message broker between the runtime environment on the wireless devices 102 and the back-end services 108. The gateway server 118 is in communication with both the provisioning server 120 and the discovery server 122. The gateway server 118 is further in communication with a plurality of the back-end servers 108, such as Web services 108a, database services 108b, as well as other enterprise services 108c, via a suitable link. For example, the gateway server 118 is connected with the Web services 108a and database services 108b via Simple Object Access Protocol (SOAP) and Java Database Connectivity (JDBC) respectively. Other types of back-end services 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternatively, if the wireless device 102 is not initially provisioned with the URL and encryption key, they may be pushed to the wireless device 102 via the mobile data server 116. The mobile device 102 can then connect with the application gateway 106 via the URL of the application gateway server 118.

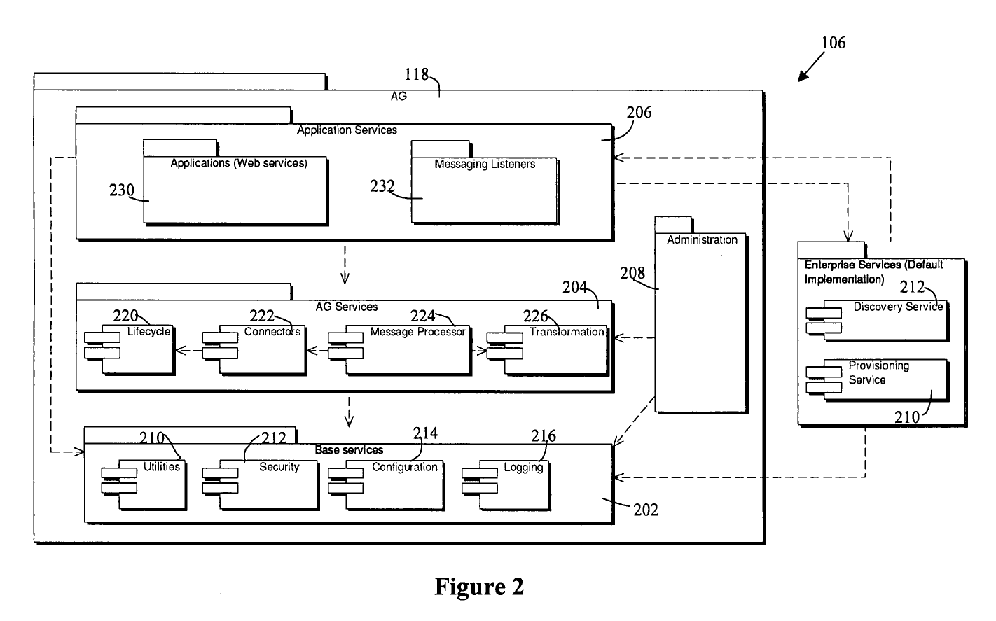

Referring to FIG. 2, a more detailed view of the application gateway 106 is shown. The application gateway server 118 includes three layers of service: a base services layer 202, an application gateway services layer 204 and an application services layer 206. The application gateway server 118 further includes an administration service 208.

A provisioning service 210 and a discovery service 212 are provided by the provisioning server 120 and discovery server 120, respectively.

At the lowest level, the base services layer 202 offers basic, domain-independent system services to other components in higher levels. Thus, for example, all subsystems in the application gateway services layer 204 and the application services layer 206 can utilize and collaborate with the subsystems in the base services layer 202. In the present embodiment, the base services layer 202 includes a utilities subsystem 210, a security subsystem 212, a configuration subsystem 214, and a logging subsystem 216.

The application gateway services layer 204 provides wireless component application domain-specific services. These services provide efficient message transformation and delivery to back-end services 108 and provide wireless device 102 and component application lifecycle management. In the present embodiment, the application gateway services layer 204 includes a lifecycle subsystem 220, a connector subsystem 222, a messaging subsystem 224, and a transformation subsystem 226.

The application services layer 206 sits at the top of the architecture and provides external program interfaces and user interfaces using subsystems provided by the lower layers. For example, various applications such as a service provider lifecycle application, a packaging application and a message listening application provide external program interfaces since they communicate primarily with applications on external systems. Similarly, an administration application provides a user interface by providing a user with ability to access and potentially modify application gateway data and/or parameters.

The administration service 208 is responsible for administrative system messages, administration of the wireless devices 102, runtime administration of the application gateway subsystems, support and display system diagnostics, and administration of default implementations of the provisioning and discovery services.

The messaging listening application provides an interface for receiving messages from the wireless devices 102 as well as external sources and forwarding them to the messaging subsystem. Further, the message listening application typically authenticates that the source of the message is valid.

The security subsystem 212 providing services used by other subsystems for securing communications with the wireless device 102. In order to facilitate secure communications, the security subsystem 212 encrypts and decrypts messages, validates signatures and signs messages.

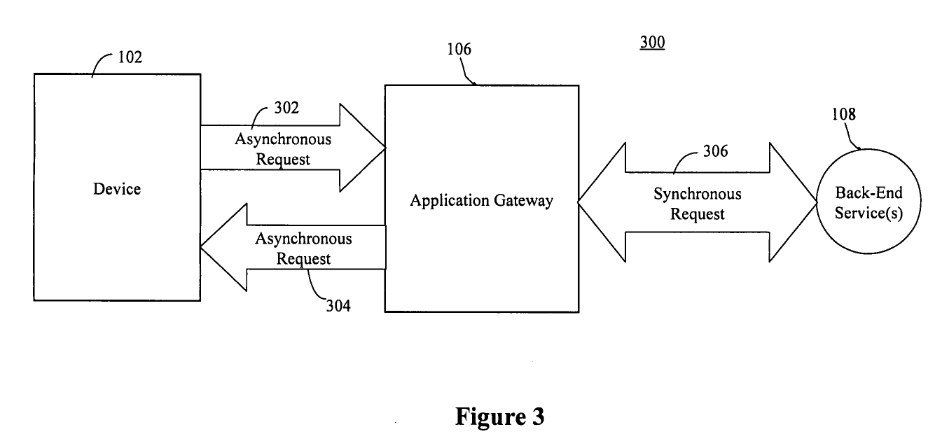

Referring to FIG. 3 there is illustrated in a block diagram a wireless component application communication model. From a high-level perspective, the overall wireless component application infrastructure 300 includes a wireless component application runtime environment (Device RE) running on the device 102 and a wireless component application gateway (AG) 106 running on the server 118.

The AG 106 serves as a mediator between a wireless component application (sometimes referred to as application in this disclosure) executed by the RE and one or more back-end services 108 with which the application communicates. Often the back-end service is expected to be a Web service 108a using SOAP over HTTP or HTTPS as the transport protocol. As Web services are the most commonly expected back-end service 108, the term Web service is used interchangeable with back-end service 108 throughout this disclosure. However, it is appreciated that other types of back-end services can also be adapted to the disclosure. FIG. 3 exemplifies a synchronous link with a back-end service 108. However, it should be appreciated that the AG 106 can be in communication with back-end services 108 over asynchronous links.

The wireless component application communication model 300 is based upon an asynchronous messaging paradigm. In this model the application gateway (AG) 106 establishes and mediates the connection between the device 102 and the back-end service(s) 108 to:
1. Achieve greater flexibility in resource management.
2. Provide reliable communication link between the device 102 and the back-end service 108 to handle situations when wireless coverage is unstable.
3. Efficiently distribute workload between the device RE 102 and the AG 106.

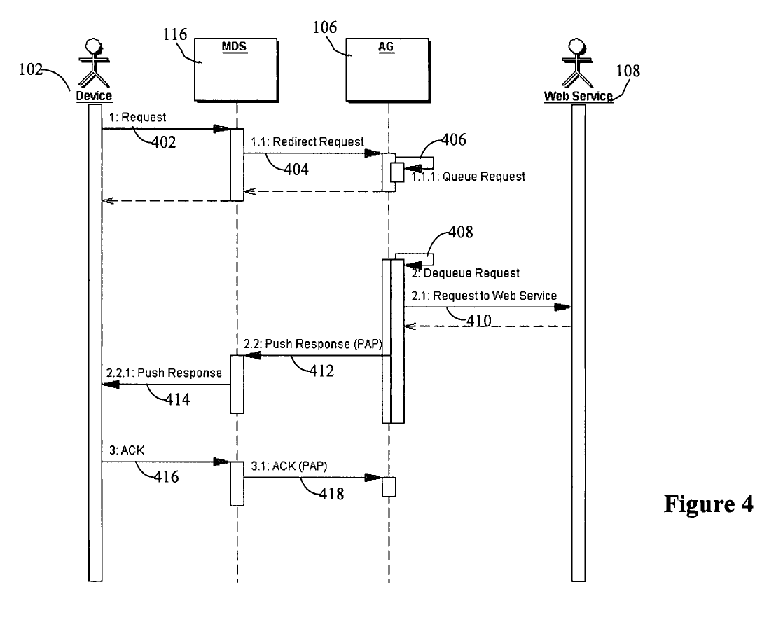

Referring to FIG. 4 there is illustrated in a sequence diagram a communication sequence for the wireless component application communication model of FIG. 3. The diagram describes the communications sequence between the device 102 and the back-end service(s) 108:
Upon receiving a request 402 from the device 102, via 404 MDS 116, AG 106 queues the request 406 and releases the connection to the device.
Next, the request is retrieved from the queue 408, pre-processed and forwarded 410 to the Web service 108a through a synchronous communication channel.
Any response from the previous request is processed by the AG 106 and a response message is sent asynchronously 412 and 414 back to the device.

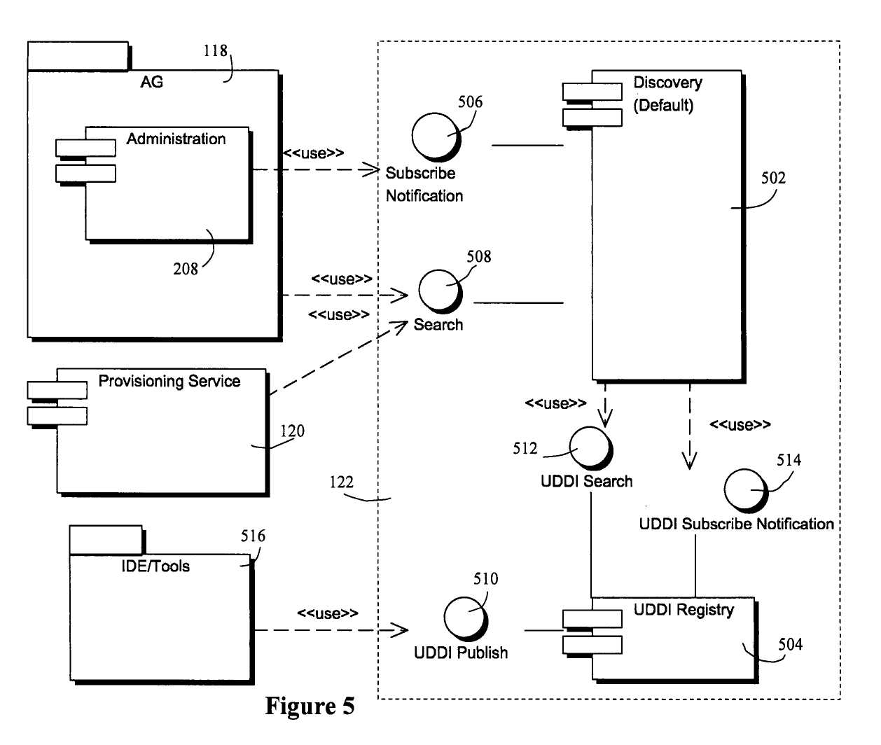

Referring to FIG. 5 is a block diagram of a discovery server of FIG. 2 shown in greater detail for discovering component applications, in accordance with an embodiment of the present patent disclosure. The discovery service 502 can be configured to be in communication with a plurality of registries that implement the UDDI specification.

Referring to FIG. 5, the discovery server 122 is shown in greater detail. The discover server 122 comprises a discovery service 502 and a Universal Description, Discovery and Integration (UDDI) registry 504. The discovery service 502 communicates with the UDDI registry 504 via a UDDI search interface 512 and a UDDI subscription notification interface 514. The discovery service 502 further communicates with the administration subsystem server 208 via a subscription notification interface 506, and with both the application gateway server 118 and the provisioning server 120 via a search interface 508. The UDDI registry 504 is in communication with an integrated development enterprise (IDE) 516 via a UDDI publish interface 510.

The UDDI publish interface 510 is a SOAP-based UDDI interface providing publishing capabilities. This interface is used by any utility that facilitates component application publishing. Accordingly, once a developer has created a component application, it can be submitted to the UDDI registry 504 by following a set of component application publication rules.

The discovery service 502 can request a notification of new or updated component applications registered with the UDDI registry 504. The UDDI subscription notification interface 514 is a SOAP-based UDDI interface provided by UDDI registry to subscribe for Registry notifications. Preferably, the support for notification is based on the UDDI v3.0 specification.

The UDDI search interface 512 provides a SOAP-based UDDI interface for searching the UDDI registry.

The default implementation of the discovery service 502 is a standalone Web service deployed as part of the application gateway 106 via the discovery server 122. The discovery service 502 offers local component application discovery services to a discovery component application on the runtime environment on the wireless devices 102. From the perspective of the application gateway server 118, the discovery service 502 is a typical component application, and is deployed and managed as such. Accordingly, processing of discovery messages is generic and transparent to the application gateway server. Thus, the application gateway server 118 serves as a message broker between the runtime environment and the discovery service 502.

Typically, the runtime environment communicates with the discovery service 502 through the search interface 508. The current search interface 508 may be replaced with another one, as long as both the discovery component application on the wireless device and the discovery service 502 support the replacement search interface.

Yet further, the default implementation of the discovery service 502 may be used to enforce the secure wireless component provisioning policy. The security is achieved since the discovery service 502 accesses only predefined local or trusted UDDI registries.

Similarly to the UDDI subscription notification interface 514, the subscription notification interface 506 is a SOAP-based interface implemented by the discovery service provider 122. The subscription notification interface 506 allows the administration subsystem 208 to subscribe for discovery notifications. Such notifications include, for example, ‘new component application version is available’ and ‘new component application is available’.

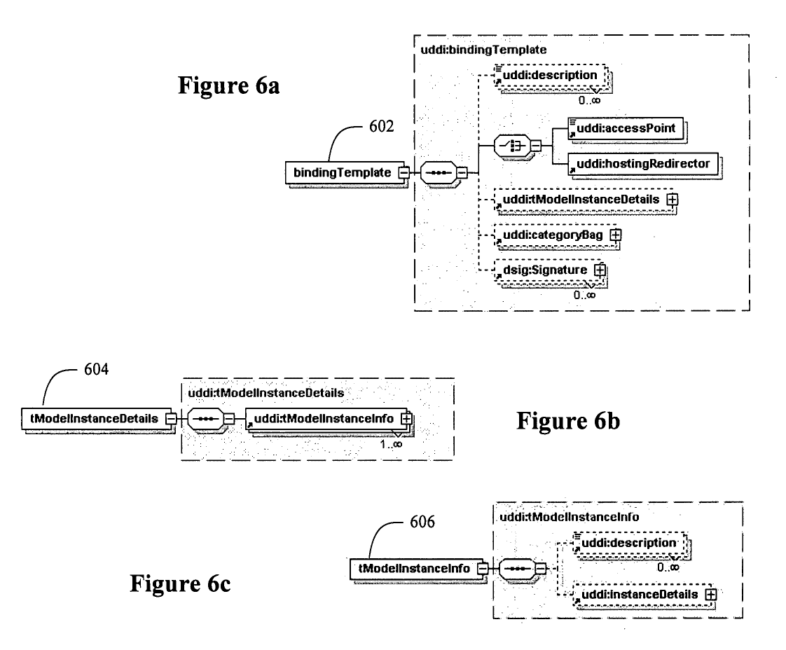

Referring to FIGS. 6a, 6b, and 6c there are illustrated in block diagrams UDDI structures for use in embodiments of the present patent disclosure. The Web service or any other entity published in the UDDI registry is stored as a binding template record 602 as shown in FIG. 6a and the binding template key uniquely identifies the binding template record 602. The original Web service binding template record 602, as well as thin client applications that refer to the binding template record 602 are enhanced at publishing with additional parameters (tModels) to facilitate the specialized query.

An example of the operation that registers a Web service or other application in the UDDI registry is provided:

```
<save_binding generic=“2.0” xmlns=“urn:uddi-org:api_v2” >
    <authInfo/>
    <bindingTemplate/> [<bindingTemplate/>...]
</save_binding>
```

The binding template structure 602 is shown in FIG. 6a. The tModelInstanceDetails 604 as shown in FIG. 6b for the Web service record/application contains a list of technical models (tModels) that characterizes this record. The tModels that enhance the Web service at publishing time are a set of the following (name, value) pairs for each thin client application that the Web service supports. For example:

‘uddi:standards.com:categorization: terminal:vendor’ = ‘Company Inc’
‘uddi:standards.com:categorization: terminal:type’ = ‘Wireless Gadget’
‘uddi:standards.com:categorization: terminal:version’ = ‘1.0’
‘uddi:standards.com:categorization: terminal:URL’ =
‘http://www.comp.com/UDDI’
‘uddi:standards.com:categorization:terminal:appBindingTemplateKey’ =
‘2001’
(optional; the application may not be located in a UDDI)

The tModels that enhance the thin client application at publishing time are one set of (name, value) pairs of the form:

‘uddi:standards.com:categorization: terminal:vendor’ = ‘Company Inc’
‘uddi:standards.com:categorization: terminal:type’ = ‘Wireless Gadget’
‘uddi:standards.com:categorization: terminal:version’ = ‘1.0’
‘uddi:standards.com:categorization: terminal:URL’ =
‘http://www.comp.com/UDDI’

Note: The ‘Terminal’ tModels names are registered with the UDDI registry prior to any application using them, and are published by using the save_tModel operation of UDDI:

```
<save_tModel generic=“2.0” xmlns=“urn:uddi-org:api_v2” >
    <authInfo/>
    <tModel/> [<tModel/>...]
</save_tModel>
```

FIG. 6c illustrates the tModel instance info structure 606. An example of a UDDI inquiry operation is:

```
<find_binding serviceKey=“uuid_key” [maxRows=“nn”] generic=“2.0”
    xmlns=“urn:uddi-org:api_v2” >
    [<findQualifiers/>]
    <tModelBag/>
</find_binding>
```

In order to specialize the query for searching only Web services that match the terminal from which the query is made, the discovery application on the terminal should specify the list of tModels that describes the terminal. For example:

‘uddi:standards.com:categorization: terminal:vendor’ = ‘Company Inc’
‘uddi:standards.com:categorization: terminal:type’ = ‘Wireless Gadget’
‘uddi:standards.com:categorization: terminal:version’ = ‘1.0’

The query operation returns only those bindingTemplate records that have been registered with tModels that match the tModelBag search criteria.

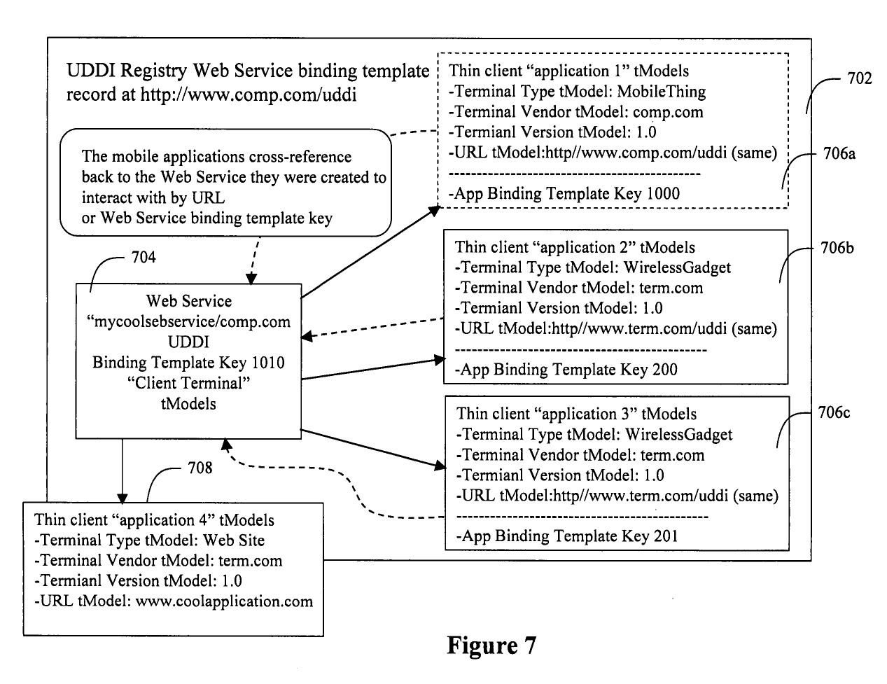

Referring to FIG. 7 there is illustrated in a block diagram of a UDDI registry illustrating how a Web services binding template of FIG. 6a is used to refer to thin client applications in accordance with an embodiment of the present patent disclosure. FIG. 7 shows an example of binding template 702 named: UDDI Registry Web service binding template record at http://www.comp.com/uddi. For a Web service:

Web service
“mycoolsebservice/comp.com
UDDI

Binding Template Key 1010
“Client Terminal”
tModels

The mobile applications 706 cross-reference back to the Web service they were created to interact with by URL or Web service binding template key. The following are examples:

mobile application 706a:

Thin client “application 1” tModels
Terminal Type tModel: MobileThing
Terminal Vendor tModel: comp.com
Termianl Version tModel: 1.0
-URL tModel:http//www.comp.com/uddi (same)
----------------------------------
App Binding Template Key 1000

mobile application 706b:

Thin client “application 2” tModels
Terminal Type tModel: WirelessGadget
Terminal Vendor tModel: term.com
Termianl Version tModel: 1.0
-URL tModel:http//www.term.com/uddi (same)
----------------------------------
App Binding Template Key 200

mobile application 706c:

Thin client “application 3” tModels
Terminal Type tModel: WirelessGadget
Terminal Vendor tModel: term.com
Termianl Version tModel: 1.0
-URL tModel:http//www.term.com/uddi (same)
--------------------------------------------
App Binding Template Key 201

In FIG. 7 a mobile application 708 is shown that does not reside in the UDDI registry.

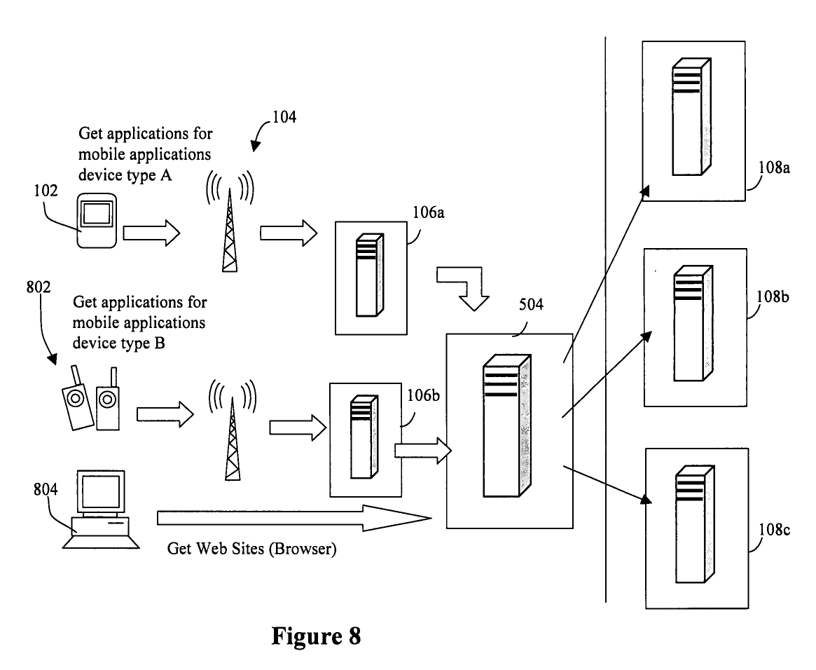

Referring to FIG. 8 there is illustrated in a block diagram the network of FIG. 1 using the UDDI registry of FIG. 7. The system depicts how various terminals inquire the UDDI registry for Web services containing thin applications that match their specification. A wireless device 102 requests applications for device type A and Wireless devices 802 requests applications for device type B via wireless network 104. By contrast a computer 804 requests websites via its browser. All three requests reach the UDDI registry 504. The first two via the wireless network 104 and proxy servers 106a and 106b, respectively. The UDDI registry 504 includes binding templates as illustrated in FIG. 7, hence is able to match various terminals with Web services using the appropriate thin clients contained therein.

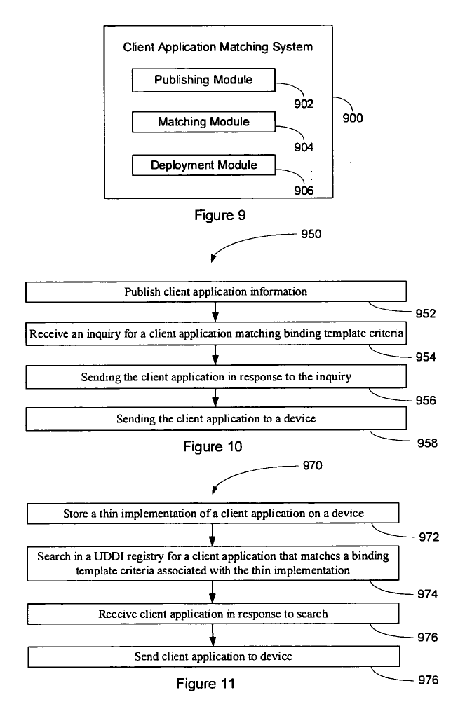

FIG. 9 shows in a component diagram an example of a client application matching system 900 for providing and obtaining client applications that match a thin client implementation, in accordance with an embodiment of the present patent disclosure. The client application matching system 900 comprises a publishing module 902 for publishing a client application to a discovery service 502 acting as a wrapper to the UDDI registry 504, a matching module 904 for searching the UDDI registry for client applications that match a thin client implementation by calling an inquiry on the discovery service 502 and a deployment module 906 for retrieving from a back-end service, and transferring to a client, a client application in response to the inquiry.

FIG. 10 shows in a flowchart an example of a method of providing client applications that match thin implementations (950), in accordance with an embodiment of the client application discovery system 900. The method (950) begins with publishing client application information to a discovery service (952). The client application information includes binding template records, binding template keys, additional parameters. Next an inquiry for a client application matching binding template criteria is received from the discovery service (954). In response to the inquiry, the client application is sent to the discovery service (956). The client application is then sent to the device (958).

FIG. 11 shows in a flowchart an example of a method of obtaining client applications that match thin implementations (970), in accordance with an embodiment of the client application discovery system 900. The method begins with storing on a device a thin implementation of a client application (972). A search in a UDDI registry for a client application that matches binding template criteria associated with the thin implementation is performed (974). The client application is received (976) by the discovery service and sent to the device (978).

The client application matching system 900 and methods according to the present patent disclosure may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A client application matching system for providing and obtaining client applications that match a thin client implementation, the client application matching system comprising:
a publishing module for publishing a client application to a discovery service acting as a wrapper to a UDDI registry;
a matching module for searching the UDDI registry for client applications that match a thin client implementation by calling an inquiry on the discovery service; and
a deployment module for retrieving from a back-end service, and transferring to a client, a client application in response to the inquiry.

2. The system as claimed in claim 1, wherein client application information is published to the discovery server, the client application information including parameters, the parameters including at least one of:
at least one binding template record; and
at least one binding template key.

3. A system for discovering Web services for a wireless device comprising:
a discovery server including a registry for discovering Web services, the registry including storage for thin clients for matching Web services with various mobile devices; and
an application gateway server for communicating with a plurality of mobile devices, the application gateway server configured for communication with a back-end service and the discovery server.

4. The system of claim 3, wherein the wireless device executes a computer browser.

5. The system of claim 3, wherein the wireless device is a cell phone.

6. A system for discovering Web services for a device comprising:
a discovery server for providing Web services for a variety of devices; and
a registry for discovering Web services, the registry including storage for thin clients for matching Web services with various devices.

7. The system of claim 6, wherein the wireless device executes a computer browser.

8. The system of claim 6, wherein the wireless device is a cell phone.

9. A method of providing client applications that match thin implementations, the method comprising the steps of:
publishing client application information to a discovery service;
receiving an inquiry for a client application matching a binding template criteria; and
in response to the inquiry, sending the client application to the device.

10. The method as claimed in claim 9, wherein the inquiry is received by a discovery service, and the client application is sent via the discovery service.

11. The method as claimed in claim 9, wherein the client application information includes parameters including at least one of:
at least one binding template record; and
at least one binding template key.

12. A method of obtaining client applications that match thin implementations, the method comprising the steps of:
storing on a device a thin implementation of a client application;
searching in a UDDI registry for a client application that matches binding template criteria associated with the thin implementation; and
receiving the client application in response to the step of searching.

13. The method as claimed in claim 12, wherein the client application is received by the device via a discovery service.

14. A method of discovering Web services for a wireless device, the method comprising the steps of:
publishing thin clients for matching various mobile devices to Web services;
searching for Web services available to a device; and
returning to the device a list of Web services available for the device.

15. The method of claim 14, wherein the wireless device executes a computer browser.

16. The method of claim 14, wherein the wireless device is a cell phone.

17. A computer-readable medium storing instructions or statements for use in the execution in a computer of a method of providing client applications that match thin implementations, the method comprising the steps of:
publishing client application information to a discovery service;
receiving an inquiry for a client application matching a binding template criteria; and
in response to the inquiry, sending the client application to the device.

18. A propagated signal carrier carrying signals containing computer-executable instructions that can be read and executed by a computer, the computer-executable instructions being used to execute a method of providing client applications that match thin implementations, the method comprising the steps of:
publishing client application information to a discovery service;
receiving an inquiry for a client application matching a binding template criteria; and
in response to the inquiry, sending the client application to the device.

19. A computer-readable medium storing instructions or statements for use in the execution in a computer of a method of obtaining client applications that match thin implementations. the method comprising the steps of:
storing on a device a thin implementation of a client application;
searching in a UDDI registry for a client application that matches binding template criteria associated with the thin implementation; and
receiving the client application in response to the step of searching.

20. A propagated signal carrier carrying signals containing computer-executable instructions that can be read and executed by a computer, the computer-executable instructions being used to execute a method of obtaining client applications that match thin implementations, the method comprising the steps of:
storing on a device a thin implementation of a client application;
searching in a UDDI registry for a client application that matches binding template criteria associated with the thin implementation; and
receiving the client application in response to the step of searching.
